(19) United States
(12) Patent Application Publication
(10) Pub. No.: US 2010/0066761 A1
(43) Pub. Date: Mar. 18, 2010

(54) METHOD OF DESIGNATING AN OBJECT IN AN IMAGE

(75) Inventors: Anne-Marie Tousch, Colombes (FR); Christophe Leroux, Versailles (FR); Patrick Hede, Longjumeau (FR)

Correspondence Address: DARBY & DARBY P.C., P.O. BOX 770, Church Street Station, New York, NY, 10008-0770, US

(73) Assignee: COMMISSARIAT A L'ENERGIE ATOMIQUE, Paris (FR)

(21) Appl. No.: 12/516,778

(22) PCT Filed: Nov. 27, 2007
(86) PCT No.: PCT/EP2007/062889

§ 371 Date: Nov. 16, 2009

(30) Foreign Application Priority Data
Nov. 28, 2006 (FR) 06/10403

(51) Int. Cl. G09G 5/00; G06K 9/34; G06K 9/62

(52) U.S. Cl. 345/629; 382/173; 382/155

(57) ABSTRACT

The present invention relates to a method of designating an object in an image. The method includes: designating a point inside the object in the image; segmenting the image into elementary regions; identifying an origin region to which the point belongs; constructing a graph of connectedness between the regions; calculating a function of membership in the object for the regions connected to the origin region, by combining various membership criteria; merging the origin region with its connected regions, a connected region being merged if the value of its membership function is greater than a predetermined threshold; wherein the steps of calculating membership functions of the connected regions and of merging is repeated for each new merged region until no merging is performed. One or more embodiments of the invention applies to image processing in order to perform the graphical designation of an object by an operation that is simple for a user.

### CROSS-REFERENCE TO RELATED APPLICATION

This is a U.S. National Phase Application under 35 U.S.C. §371 of International Application no. PCT/EP2007/062889, filed Nov. 27, 2007, and claims benefit of French Patent Application No. 06 10403, filed Nov. 28, 2006, both of which are incorporated herein. The International Application was published in French on Jun. 5, 2008 as WO 2008/065113 under PCT Article 21 (2).

### BACKGROUND OF THE INVENTION

The present invention relates to a method of designating an object in an image. The invention applies notably in respect of image processing with a view to performing the graphical designation of an object by an operation that is simple for a user.

An operator may notably wish to avail himself of an automatic function for delimiting an object, designated beforehand by a simple capture operation such as for example a single mouse click, on a video image without his needing to pinpoint an entire zone of pixels belonging to the object, or to draw a contour line or a box encompassing the object. Such a functionality is notably beneficial for handicapped persons who can perform only a single click or an equivalent object designation and cannot perform additional operations such as a mouse movement in order to frame an object to be selected. This functionality is also beneficial when an image exhibits a large quantity of objects to be selected. The operator thus wishes to designate an object on a video image for example through a simple click and automatically obtain the visualization of the designated object, through an encompassing box or a color patch for example.

A technical problem is the fine tuning of automatic processing for delimiting the image of an object in an image through the selecting by the user of a point in the image of the object.

Various image processing techniques have been developed, but none exhibits sufficiently reliable and robust results faced with the variations in brightness, form or texture of the objects.

There exist processing algorithms making it possible to pinpoint objects in an image when these objects have a basic geometric form, of the disk or rectangle type for example, or else a specific uniform color or sufficiently sharp contours. These algorithms are no longer effective in general for images of arbitrary objects on account of the complexity of their images, of the similarities of color between objects and backgrounds, or of the lack of contrast notably.

A first category of image processing is based on automatic detection of the contours of an object. Nevertheless, this method induces errors due to the significant brightness variations in the images, to shadow effects or to texture variations, erroneously interpreted by this method as object contours.

There are other object designation methods, for example involving the images from two cameras, one of the cameras being for example fixed and the other mobile and guiding the motion of an arm of a robot. There is however a requirement for a procedure not requiring any additional camera, nor any preparation of the objects to be captured, notably no prior marking of the objects with the aid of target points.

In the processing of images in general for the identification of objects, there is much research into the global segmentation of images with the aim of searching for all the objects present in an image. The objective generally desired in image segmentation is the splitting of the whole image into objects. Nevertheless, the generality of the objective leads to the use of photometric attributes, color notably, which by themselves do not make it possible to reconstruct an object. Consequently the semantics associated with the objects remains remote from the semantics that a human being can associate therewith.

### SUMMARY OF THE INVENTION

An aim of the invention is notably to allow the designation of an object, through a single interaction on an image, differentiating it from the remainder of the image. For this purpose, the subject of the invention is a method of designating an object in an image, the method including:
a step of designating a point P₁ inside the object in the image;
a step of segmenting the image into elementary regions;
a step of identifying an origin region R₁ to which the point P₁ belongs;
a step of constructing a graph of connectedness between the regions;
a step of calculating a function of membership in the object for the regions connected to the origin region R₁, by combining various membership attributes;
a step of merging the origin region R₁ with its connected regions, a connected region being merged if the value of its membership function is greater than a given threshold;
   the steps of calculating membership functions of the connected regions and of merging being repeated for each new merged region until no merging is performed.

The merging step includes for example the following steps:
a step of calculating the function of membership in the object for the regions connected to the origin region R₁;
a step of merging the origin region R₁ with the closest connected region the value of whose membership function is greater than a given threshold;
a step of updating the connectedness graph as a function of the new merged region;
   the merging step subsequently including the following iterative steps:
a step (71, 72) of calculating a function of membership in the object for the regions connected to the new merged region Rᵢ;
a step of merging (73) the merged region Rᵢ; with the closest connected region Rⱼ the value of whose membership function is greater than a given threshold;
a step of updating the connectedness graph as a function of the new merged region.

Advantageously, the calculation of the function of membership of the region in the object is done for example through a fuzzy operation μ₀ combining several attributes characterizing the dissimilitude of the connected region Rⱼ with the merged region Rᵢ.

Several types of attributes can be used, including for example the following attributes:
the remoteness of the region Rⱼ from the designation point P₁;
the distance of the center of gravity of the region Rⱼ; from the edge of the image;
the density of the region Rⱼ defined as the ratio of its area to the area of its encompassing box;
the compactness of the region Rⱼ defined as the ratio of the square of its perimeter to its area;
the symmetry in relation to an axis of the image, a region symmetric to a region belonging to the object being liable to belong to this object.

Advantageously, the method includes for example a step of recognizing the object, said method using a criterion making it possible to compare the object with the elements of a dictionary.

The point P₁ is for example designated by means of a capture interface of mouse type.

### BRIEF DESCRIPTION OF THE DRAWINGS

Other advantages and characteristics of the invention will become apparent with the aid of the description which follows offered in relation to appended drawings which represent:

FIGS. 1a, 1b and 1c, an exemplary segmentation according to the prior art from an original image;

FIG. 2, an exemplary desired segmentation result;

FIG. 3, an illustration of the possible steps of a method according to one or more embodiments of the invention;

FIGS. 4a and 4b, an illustration of two possible segmentations of an image;

FIG. 5, an illustration of a connectedness graph used in a method according to one or more embodiments of the invention;

FIG. 6, an illustration of a connectedness link;

FIG. 7, an illustration of the possible steps of an iterative process applied in a step of merging the regions of a method according to one or more embodiments of the invention.

### MORE DETAILED DESCRIPTION

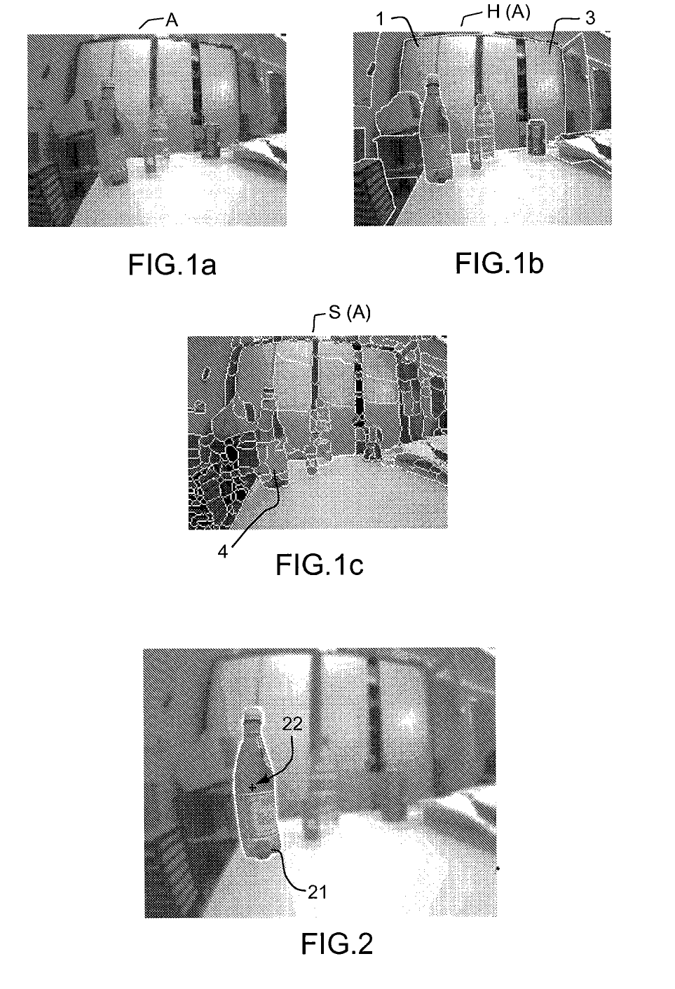

FIGS. 1a, 1b, 1c illustrate, by way of example, the result of a global procedure for segmenting an image according to the prior art, FIG. 1a presenting the original image, FIG. 1b a target segmentation and FIG. 1c the segmentation ultimately obtained.

FIG. 1a illustrates an original image A. The aim of a conventional automatic global segmentation is to obtain an image H(A) illustrated by FIG. 1b. In this image H(A) one seeks to carry out a segmentation of the whole of the image into semantic regions 1, in which each object of the foreground 2 or of the background 3 is individually isolated. FIG. 1c illustrates the segmented figure S(A) ultimately obtained where an over-segmentation with respect to the ideal image H(A) is observed, sub-segments 4 being created inside the objects.

The sub-segments 4, obtained by automatic segmentation, form elementary regions as opposed to the semantic regions of FIG. 1b obtained by human segmentation.

More generally, the main limits of conventional automatic segmentation are the following:
similarly colored but remotely distant regions forming part of the same object are not always included in one and the same segment;
similarly colored and close regions forming part respectively of the object and of the background may be included in one and the same segment;
very differently colored, neighboring regions forming part of the same object are likewise not always included in one and the same segment;
finally, very differently colored, neighboring regions forming part of the object and of the background may be grouped together in one and the same segment.

The parameters of distance between regions and of color are therefore alone insufficient to determine whether a region belongs to the object or to the background. It is then difficult to automatically merge regions so as to group them into zones corresponding to the various objects.

A conventional global segmentation does not therefore make it possible to reliably segment an image into semantic objects, since it culminates:
either in an over-segmentation of the image such as illustrated by FIG. 1c, where each object is split up into zones which are difficult to group together;
or in a sub-segmentation of the image, which does not make it possible to isolate the objects from the background.

FIG. 2 is an illustration of an exemplary desired result, that can be obtained through a method according to one or more embodiments of the invention. An object 21 situated in a part of the image is indicated by an operator, through a simple mouse click for example, and the zone of the image corresponding to the object thus designated is differentiated from the whole of the remainder of the image.

In FIG. 2, a cross 22 is an exemplary designation point performed by an operator, for example by means of a mouse click. The desired segmentation D(A) is a binary segmentation, the region corresponding to the designated object 21 being separated from the remainder of the image or background. In the example of FIG. 2, it is notably possible for everything corresponding to the background of the image to be rendered fuzzy. This background contains several objects in the sense of a conventional segmentation.

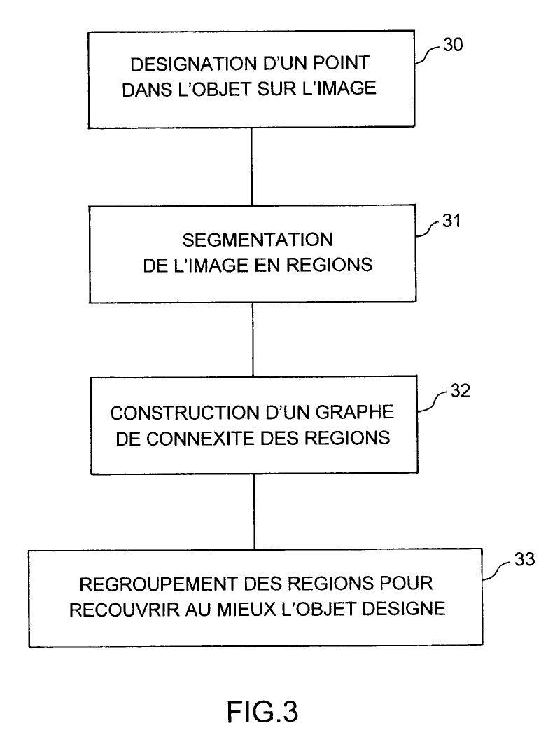

FIG. 3 illustrates possible steps for implementing the method according to one or more embodiments of the invention.

The method includes a preliminary step 30 of designating a point in the object on the image. In an image displayed on a graphical interface an operator designates a point forming part of the object that he wishes to designate, by means of a capture interface, for example a mouse, a “trackball” or any other device suited to the user's profile. In the example of FIG. 2 the object 21 is designated by a point represented by a cross 22. The image can for example undergo an additional, optional, step of low-level filtering. In this step, the image is filtered so as to reduce its size, for example on a reduced number of colors.

In a first step 31, the method carries out a segmentation of the image A into regions. The image on which the designation is done is split up into regions by way of an image segmentation procedure, for example through the use of a watershed line technique or anisotropic diffusion technique.

The method includes a second step 32 of constructing a connectedness graph of the regions. In this step, a connectedness graph of the regions is determined on the basis of this segmentation.

In a third step 33, the method groups the regions so as to best cover the designated object. The position of the click on the image is for example used as reference marker to aggregate regions assumed to belong to the object. The regions to be merged are determined by structural criteria, dependent on or independent of the position of the click. These criteria may be inclusive or exclusive.

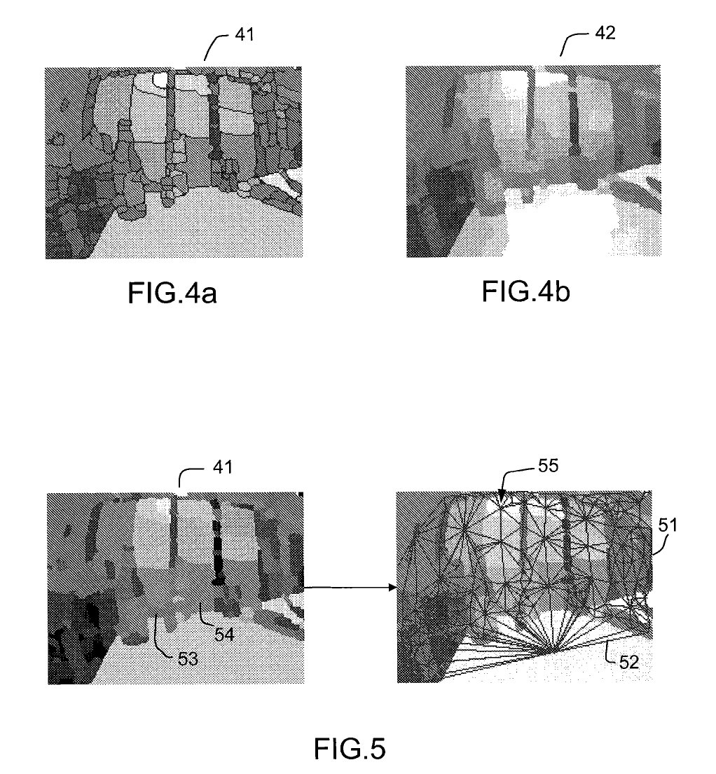

FIGS. 4a and 4b illustrate two examples of segmenting the image executed during the aforementioned first step 31. This first step is the segmentation of the raw or initial image, the aim of which is to split the image into homogeneous regions. The objective of the segmentation is to have regions which best correspond to the objects present in the image, and if possible having regular boundaries between them. This segmentation provides a number of elements smaller in number than the number of pixels of the initial image. At this juncture, it is not possible to know whether various zones belong to one and the same object.

FIGS. 4a and 4b illustrate two examples of segmenting the original image A of FIG. 1a, which are obtained according to known procedures or algorithms. FIG. 4a illustrates a first segmentation procedure achieved by anisotropic diffusion, the segmented figure 41 is obtained through a contour-based procedure. A document Ma, W. Y. and B. S. Manjunath: Edge Flow: A technique for boundary detection and segmentation. IEEE Transactions on Images Processing, pp 1375-1388, August 2000, describes a contour-based segmentation procedure. The image 41 is moreover for example obtained by anisotropic diffusion. The anisotropic diffusion alters the whole image so as to smooth the homogeneous regions and to increase the contrast at the contour level.

FIG. 4b presents a segmented figure 42 obtained by the so-called watershed line procedure. The watershed line is the model characteristic of image segmentation by mathematical morphology procedures. The basic principle includes describing the images as a topographic surface. A work by G. Matheron and J. Serra “The Birth of Mathematical Morphology”, June 1998 describes this procedure.

Generally, several procedures for segmenting into regions may be used. In particular, the following criteria may be used:
based on contours, as illustrated by FIG. 4a;
based on homogeneous connected pixel sets, as illustrated by FIG. 4b.

The splitting obtained is not related to any information about the distances. A significant result is notably that the segmentation generates regions as close as possible to the objects, in particular as close as possible to their structure. The segmentation makes it possible to have regions corresponding exactly, or almost, to the various parts of an object. A region can notably be characterized by its mean color, its center of gravity, its encompassing box and its area. The segmentation of the image into homogeneous regions is dependent on these parameters. Other parameters can optionally be taken into account.

In the example of a green colored mineral water bottle made of plastic the segmentation ought if possible to enable notably regions corresponding respectively to the stopper, to the label and to the green plastic to be obtained.

FIG. 5 is an illustration of a connectedness graph obtained on completion of the aforementioned second step 32. A connectedness graph is a conventional structure used in image segmentation for the merging of regions. More particularly, FIG. 5 illustrates by way of example a connectedness graph 51 obtained from the segmented image 41 of FIG. 4a. The input image is represented by the set of its pixels {pᵢ}. Pₐ={Rₖ}_{1≦k≦M} is the set of the regions forming the partition of the image into M regions, obtained by segmentation, for example by the watershed procedure or by the potential-contours procedure. This partition is represented by an adjacency graph of the regions, or connectedness graph, G=(N, a), where:
N={1, 2, . . . M} is the set of nodes;
a={(i, j, δ_{i, j}) such that Rᵢ and Rⱼ are adjacent} is the set of edges.

An edge in fact represents a link between regions. Each edge is characterized by a dissimilitude measure δ_{i, j} which corresponds to an inter-region merging criterion.

It is notably on this criterion that the quality of the final segmentation depends, as shown in particular by a document by Brox, Thomas, Dirk Farin, & Peter H. N. de With: “Multi-Stage Region Merging for Image Segmentation” In 22^{nd} Symposium on Information Theory in the Benelux, pages 189-196, Enschede, N L, May 2001.

In FIG. 5, dashes 52 indicate the existence of connectedness links between regions 53, 54 pairwise. In the graph G=(N, a), each node 55 represents a region and each link 52 is weighted by a dissimilitude measure δ_{i, j}.

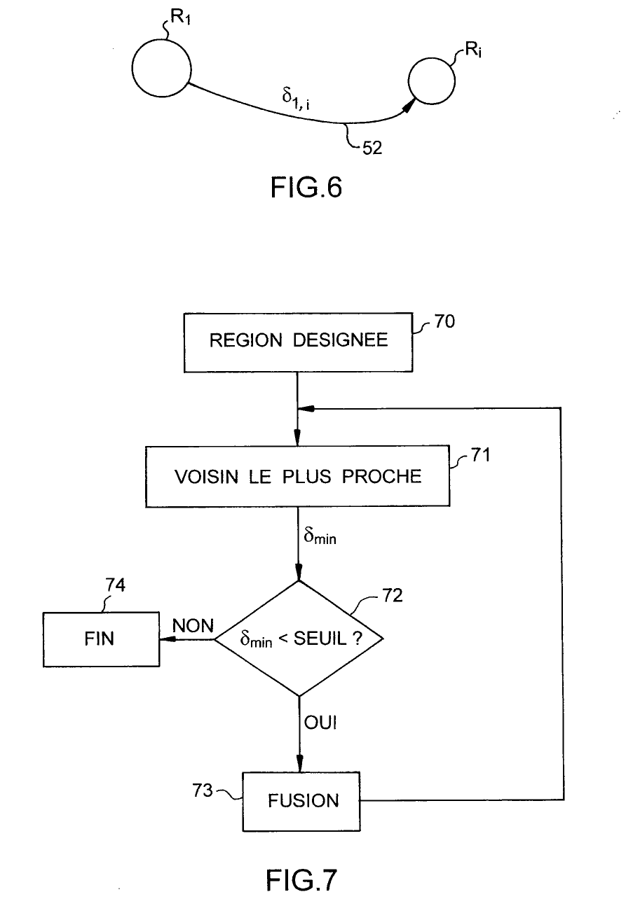

FIG. 6 illustrates a connectedness link between two regions R₁, Rᵢ. The link 52 is characterized by a dissimilitude measure δ_{1, i}. A point P1, symbolized by the cross 22, is designated in the region R₁ inside an object 21 in the image. From among the regions Rᵢ neighboring the region R₁ to which the point P1 belongs, the method seeks those which can be merged with the latter region, with the aid of the connectedness graph, and more particularly with the aid of the dissimilitude measures characterizing the links between regions. More particularly, a region Rᵢ is merged with the region R₁ as a function of the value of the dissimilitude measure δ_{1, i}. This dissimilitude measure can notably be dependent on several criteria or attributes, such as for example the remoteness of the click point, membership in the background, compactness, symmetric aspect, regularity of the envelope, texture or else colors.

FIG. 7 illustrates the steps implemented in the step 33 of grouping, or merging, the regions. In this step, one seeks to obtain an aggregate of regions so as to determine a window surrounding the object. FIG. 7 illustrates a process for merging the regions relying on a new dissimilitude measure. Merging starts from an origin region R₁ designated by the click. It is assumed that the region R₁ belongs to the designated object. The process illustrated by FIG. 7 makes it possible to widen the region R₁, through successive mergings with other regions, as far as the edges of the object on the image.

In a step 70 preliminary to the process, a region R₁ is for example designated, by a click for example. Regions Rᵢ are successively merged. The iterative progress of steps 71, 72, 73 of the process makes it possible to merge a region at each iteration. During a given iteration, the process seeks to merge a neighboring region Rⱼ with a region Rᵢ already merged into the initialized aggregate around the region R₁.

In a first step 71, the process identifies the neighboring region Rⱼ closest to the region Rᵢ among the neighboring regions. A neighboring region is defined as a region having a connectedness link 52 with the region Rᵢ. The neighboring region closest to the region Rᵢ is the region Rⱼ whose link with the region Rᵢ exhibits the lowest dissimilitude measure δₘᵢₙ.

In a second step 72, the process seeks to ascertain whether this neighboring region Rⱼ belongs to the object. For this purpose, the process executes for example a fuzzy measure of object membership based on the use of the various criteria characterizing the dissimilitude measure. These criteria are for example, as indicated previously, the remoteness of the click point, membership in the background, compactness or density, symmetric aspect, regularity of the envelope, texture or else colors.

In a third step 73, the region Rⱼ is merged with the region Rᵢ if it belongs to the object, that is to say if the membership measure is less than a threshold. The connectedness graph is consequently updated, in particular the connectedness link between the regions Rⱼ and Rᵢ is deleted following the merging of these two regions. The process then resumes at the level of its first step 71.

When merging no longer occurs, or if no neighboring region is elected, the process stops in a step 74.

According to one or more embodiments of the invention the membership of a region Rⱼ in an object 21 is determined with the aid of a function using fuzzy operations on the measures of the various criteria from among those aforementioned. By way of example, four criteria are described hereinafter. These criteria are combined by fuzzy logic operations so as to obtain a global measure which will be compared with the threshold of the second step 72 of the merging process.

It is thus possible to represent the location of a region Rⱼ with respect to the designation point 22, or the click, by a function μ_{L} depending both on:
vertical and horizontal deviations of the center of the neighboring region Rⱼ considered with respect to the center of the region R₁;
the deviation of the center of gravity of the region corresponding to the merging of the region R₁ of the designation point 22 with the neighboring region Rⱼ considered, still with respect to this designation point 22.

It is also possible to define for each region a criterion of membership in the background as a function of its distance from the edge of the image. The distance of the center of gravity from the edge of the image is then denoted μ_{B}.

It is further possible to use measures of density or compactness. The area of a region is denoted A(Rᵢ), the perimeter of the region is denoted p(Rᵢ) and the area of its encompassing box is denoted BB(Rᵢ), which may for example be a rectangle. The density measure can then be defined by the function:

$${μ}_{D} = \frac{A ( {R}_{i} )}{BB ( {R}_{i} )}$$

and the compactness measure can be defined by the function:

$${μ}_{S} = \frac{{p}^{2} ( {R}_{i} )}{A ( R )}$$

The combination of the various criteria is done through fuzzy logic operations. The four previous functions can for example be combined to obtain a membership criterion μ₀ defined according to the following relation:

μ₀=(μ_{B}) [symbol] (μ_{L}² [symbol] (μ_{L} [symbol] μ_{D}) [symbol] (μ_{L} [symbol] μ_{S})) (1)

The symbols [symbol] and [symbol] represent the logic functions “and” and “or”, this signifies notably that in relation (1) when two criteria are linked by [symbol] both criteria are taken into account. When two criteria are linked by [symbol] one or the other of the criteria is taken into account, or both at once.

For a given region Rᵢ, the criterion μ₀ is a criterion of membership in the object including the region R₁ of the initial click.

Like the other functions μ_{B}, μ_{L}, μ_{D}, μ_{S}, μ₀ to is a function of the region Rᵢ which characterizes its link with the neighboring region Rₖ considered. μ₀(Rᵢ) forms a measure of dissimilitude δₘᵢₙ between the region Rᵢ and the region Rₖ. The larger μ₀(Rᵢ), the smaller the dissimilitude. The comparison of the second step 72 then amounts to comparing μ₀(Rᵢ) with a threshold, merging taking place if μ₀(Rᵢ) is greater than this threshold.

An additional criterion of membership in the object can be the detection of the symmetries in the region resulting from the merging of two elementary regions Rᵢ, Rⱼ. The process then makes the assumption that the object or objects sought exhibit horizontal and vertical axes of symmetry. In numerous applications, the objects to be designated are mainly manufactured objects and exhibit indeed for the most part a vertical axis of symmetry. A procedure for extracting the axes of symmetry, which relies on the gradient of the image, is described in the document by D. Reisfeld, H. Wolfson & Y. Yeshurun: “The discrete Symmetry Transform in Computer Vision” Int. J. of Computer Vision, Special Issue on Qualitative Vision, 14: 119-130, 1995. The process selects a pixel and searches on one and the same line, respectively one and the same column, for a pixel which exhibits a similitude in the image of the gradients, that is to say the image resulting from the step of detecting the contours during the segmentation phase. The process thereafter searches for the symmetries on a line, then on a column. The points exhibiting a similitude are thereafter stored in an accumulation table so as to determine the center of symmetry of the object, the center of symmetry being the point equidistant from all these accumulated points. A procedure, making it possible to detect central symmetry points, is notably described in the document by G. Loy & A. Zelinsky: “Fast Radial Symmetry for Detecting Points of Interest”, IEEE Transactions on Pattern Analysis and Machine Intelligence, 25(8): 959-973, 2003, ISSN 0162-8828.

A symmetry criterion can then be used for the merging, specifically a region symmetric to a region belonging to the object may also belong to this same object.

In an implementation variant, the method according to the invention includes an additional recognition step. It is then possible to supplement the location and capture of the object with its recognition. In this case, the method according to the invention introduces a criterion making it possible to compare the object with the elements of a dictionary. This involves notably recognizing the object included in the final region. On a base of images mustering as many objects as possible from everyday life, an index is defined and makes it possible to discriminate the various objects represented by the images of the base. On completion of the merging of regions, the method according to the invention makes it possible to obtain an image representing an object more or less. This image is presented to an indexer which calculates the distance to each of the objects of the base and returns the list of objects sorted by order of increasing distance for example. It is then possible to deduce therefrom the most probably designated object.

In addition to the possible applications for improving the capture of an object, or for anticipating its use, this recognition makes it possible notably to enrich the final region corresponding to the object by merging new regions therewith or to call into question the merging so as to delete certain regions or pixels of the recognized zone. For example if the form of a bottle has been recognized, certain protuberance-like regions which do not correspond to the form of a bottle, can be deleted. In the same manner, certain regions can be added to supplement the recognized form. The recognized forms correspond to semantic regions which correspond to a more natural segmentation for humans, allowing the discrimination of the various graspable objects. The previous elementary regions Rᵢ are obtained by automatic image segmentation techniques. The fuzzy measures used make it possible to measure the degree of membership of an elementary region in a semantic region. The use of fuzzy measures lends itself advantageously well to this uncertainty in the membership of a region in the object, the latter corresponding to a semantic region.

In conventional procedures, it is possible to use segmentation into fuzzy regions where a pixel belongs to a region according to a certain degree. In the method according to one or more embodiments of the invention, in contradistinction to conventional procedures in which a pixel belongs in a fuzzy manner to one or more regions, a pixel belongs to a single region at one and the same time in a binary manner. It is the elementary regions which belong in a fuzzy manner to the semantic regions. Advantageously, the method according to one or more embodiments of the invention is less sensitive to noise. Another advantage is notably that it gives the merging a clear formalism, making it possible to obtain a membership criterion that can easily be enriched by adding complementary criteria.

Advantageously, the invention allows numerous applications. In particular, it makes it possible to trigger the automatic capture of an object by means of a manipulator arm so as to allow, for example:
the designation of the object in one click by the user on the video image;
the validation of the choice by the user;
the activation of a robot arm for the capture.

This step can optionally be chained together with a subsequent step of recognizing or identifying the object, for example via an indexation of images in a library of images.

The object designation method according to one or more embodiments of the invention can also advantageously be chained together with an independent method of automatic capture of the object, for example by means of a robot arm. In this case, the object is sensed by a camera, for example integrated into the robot. The operator, for example a handicapped person, designates the object on an image transmitted by the camera by means of a click or any other elementary means. The robot arm subsequently manipulates the object designated according to predefined instructions for example.

1. A method of designating an object in an image, comprising the following steps:
designating a point inside the object in the image, to produce a designated point;
segmenting the image into a plurality of elementary regions
identifying an origin region to which the designated point belongs;
constructing a graph of connectedness between the plurality of elementary regions;
calculating a membership function of the object for each region of a plurality of connected regions by combining predetermined membership attributes, wherein each said connected region comprises a region connected to the origin region;
merging the origin region with a connected region if a value of the membership function for the connected region is greater than a predetermined threshold, to form a new merged region; and
repeating the steps of calculating membership functions and merging the origin region until no merging is performed.

2. The method as claimed in claim 1, wherein the merging step comprises:
calculating the membership function of the object for the regions connected to the origin region;
merging the origin region with the closest connected region that has a membership function value greater than a predetermined threshold;
updating the connectedness graph as a function of the new merged region;
iteratively performing the steps of:
calculating a membership function of the object for each region of a plurality of regions connected to the merged region;
merging the merged region with a closest connected region that has a membership function value greater than a predetermined threshold;
updating the connectedness graph as a function of the new merged region.

3. The method as claimed in claim 1, wherein the calculation of the membership function of the region in the object by comprises a fuzzy operation that combines several predetermined attributes that characterize a dissimilitude of the connected region Rⱼ with the merged region Rᵢ.

4. The method as claimed in claim 3, wherein an attribute of the fuzzy operation comprises a remoteness of the region Rⱼ from the designated point.

5. The method as claimed in claim 3, wherein an attribute of the fuzzy operation comprises a distance of a center of gravity of the region Rⱼ from an edge of the image.

6. The method as claimed in claim 3, wherein an attribute of the fuzzy operation comprises a density of the region determined by the ratio of its area to an area of its encompassing box.

7. The method as claimed in claim 3, wherein an attribute of the fuzzy operation comprises a compactness of the region determined by a ratio of a square of its perimeter to its area.

8. The method as claimed in claim 3, wherein an attribute of the fuzzy operation comprises a symmetry in relation to an axis of the image, wherein a region may belong to the object if the region is symmetric to a region that belongs to the object.

9. The method as claimed in claim 1, further comprising a step of recognizing the object by use of a criterion to compare the object with elements of a dictionary.

10. The method as claimed in claim 1, wherein the designated point is designated by use of a mouse.
